(19) United States
(12) Patent Application Publication
(10) Pub. No.: US 2017/0217419 A1
(43) Pub. Date: Aug. 3, 2017

(54) VEHICLE BRAKE SYSTEM HEALTH DIAGNOSTIC, PROGNOSTIC, AND REPORTING APPARATUS

(71) Applicant: GLOBAL TECHNOLOGY OPERATIONS LLC, Detroit, MI (US)

(72) Inventors: Chih-hung Yen, Bloomfield Hills, MI (US); Taeyoung Han, Bloomfield Hills, MI (US); Kee H. Im, Rochester Hills, MI (US); Steven J. Weber, Mount Clemens, MI (US)

(21) Appl. No.: 15/412,487

(22) Filed: Jan. 23, 2017

Related U.S. Application Data
(60) Provisional application No. 62/288,857, filed on Jan. 29, 2016.

(51) Int. Cl. B60T 17/22; B60T 7/04; B60T 13/14

(52) U.S. Cl. CPC B60T 17/221; B60T 13/145; B60T 7/042; B60T 2210/10; B60T 2210/20; B60T 2210/30; B60T 2220/04; B60T 2270/403

(57) ABSTRACT

Apparatus for prognosing a vehicle brake-system health issue, and processes performed thereby. The apparatus in various embodiments includes a first sensor and a second sensor. In various embodiments, the first sensor is configured to measure a brake system input, such as brake pedal force or displacement, and the second sensor configured to produce output indicative of vehicle deceleration. The apparatus further includes a processing hardware unit, and a non-transitory computer-readable storage device. The storage device includes a prognostic module configured to cause the processing hardware unit to determine, based on the data received from the first sensor and the second sensor, whether there is an existing or potential brake-system health issue. In some implementations, the first sensor or the second sensor is configured to measure brake-line pressure.

### TECHNICAL FIELD

The present disclosure relates generally to apparatus for analyzing vehicle brake systems and, more particularly, to apparatus for diagnosing, prognosing, and reporting issues of vehicle brake systems.

### BACKGROUND

This section provides background information related to the present disclosure which is not necessarily prior art.

Current techniques for determining whether a brake system is in proper health are limited mainly to analyzing remaining brake-pad thickness. Pad thickness can be measured by sensor and the user advised of the need to change the pad. In some cases, users determine that the pads are thin based on physical feedback in braking episodes, such as noise or rough feel.

There are many issues in the braking system beyond brake pad wear that can be problematic. Users cannot sense most issues, though, and the ones that they can sense can typically only be sensed after the problem is well developed. Example user sensations for these issues again may include noise and rough feel, and others such as soft pedal, pedal-to-the-floor being required to stop, and the vehicle veering or pulling in braking.

There are currently no techniques for diagnosing all existing and potential brake-system issues, such as apparent early-stage issues, at the vehicle, automatically and before the issues become advanced.

### SUMMARY

There is a need for apparatus that can automatically diagnose early-stage brake system health issues at the vehicle. Brake system health issues can include degradation or a fault in the brake system, including by not limited to brake pad wear.

There is also a need for systems that can report results of the diagnosis to interested parties, such as to a driver or other vehicle user, a service center, such as a dealership maintaining the vehicle, and a manufacturer of the vehicle.

In one aspect, the technology includes apparatus for prognosing a vehicle brake-system health issue. The apparatus includes a first sensor configured to measure a brake system input, and a second sensor configured to produce output indicative of vehicle deceleration. The apparatus also includes a processing hardware unit, and a non-transitory computer-readable storage device comprising a prognostic module configured to cause the processing hardware unit to determine, based on the data received from the first sensor and the second sensor, whether there is an existing or potential brake-system health issue.

The brake system input may include one or both of an amount of brake-pedal displacement and an amount of force applied to a vehicle brake pedal.

The second sensor in various embodiments includes at least one of an accelerometer and a vehicle wheel-speed sensor, output of the wheel-speed sensor over time indicating vehicle deceleration.

The prognostic module may be configured to cause the processing hardware unit to receive contextual data, and the prognostic module can base determination of whether there is the existing or potential brake-system issue on the contextual data in addition to the data received from the first sensor and the second sensor.

### The contextual data indicates at least one of a vehicle load, a road slope, a road surface condition, a vehicle height, and a weather condition, in various embodiments.

The prognostic module may cause the processing hardware unit to determine whether there is an existing or potential brake-system health issue, yields a brake-system health determination, and in various embodiments the non-transitory computer-readable storage device includes a reporting module configured to cause the processing hardware unit to deliver a communication corresponding to the brake-system health determination to a destination. Example destinations include a user-vehicle interface, such as a vehicle display or vehicle speaker, a vehicle-user mobile communication device, a remote computing system of a customer-support center, a remote computing system of a vehicle manufacturer, a remote computing system of a service center servicing vehicles like the vehicle, a remote computing system of a vehicle dealer, and a remote computing system of a vehicle designer.

Among other information, the communication may include a recommended remediation for the brake-health issue.

The prognostic module, in various embodiments, bases determination of whether there is an existing or potential brake-system issue on multiple pieces of data received from the first sensor and the second sensor over time and/or on historic information related to vehicle braking performance.

The prognostic module, in causing the hardware processing hardware unit to determine whether there is the existing or potential brake-system issue, may determine whether the sensor data falls within or outside of a pre-set threshold.

The non-transitory computer-readable storage device in various embodiments includes a diagnostic module that, when executed by the hardware processing hardware unit, determines a reason for the existing or potential brake-system issue. And the diagnostic module may, when executed by the non-transitory computer-readable to determine the reason for the existing or potential brake-system issue, determine the reason based on the sensor data being within or outside of a pre-set data threshold or pre-established data zone.

In another aspect, the technology relates to apparatus, for prognosing a vehicle brake-system health issue, including a first sensor configured to measure vehicle brake-line pressure and a second sensor configured to produce output indicative of vehicle deceleration. The apparatus includes a processing hardware unit, and a non-transitory computer-readable storage device comprising a prognostic module configured to cause the processing hardware unit to determine, based on the data received from the first sensor and the second sensor, whether there is an existing or potential brake-system health issue.

In still another aspect, the technology relates to an apparatus, for prognosing a vehicle brake-system health issue, including a first sensor configured to measure a brake system input and a second sensor configured to measure vehicle brake-line pressure. The apparatus further includes a processing hardware unit and a non-transitory computer-readable storage device comprising a prognostic module configured to cause the processing hardware unit to determine, based on the data received from the first sensor and the second sensor, whether there is an existing or potential brake-system health issue.

Other aspects of the present invention will be in part apparent and in part pointed out hereinafter.

### DESCRIPTION OF THE DRAWINGS

FIG. 1 illustrates schematically example features of a vehicle brake system and components of the diagnostic apparatus according to various embodiments of the present technology.

FIG. 2 shows a specially configured computer system to perform operations of the present technology.

FIG. 3 shows features of a non-transitory computer-readable storage device of the computer system of FIG. 2.

FIG. 4 shows an example operation flow of processes of the present technology.

FIG. 5 is a graph showing example relationships between brake-pedal force and brake-line pressure.

FIG. 6 is a graph showing example relationships between brake-pedal travel and brake-line pressure.

FIG. 7 is a graph showing example relationships between brake-line pressure and vehicle deceleration.

FIG. 8 shows the graph of FIG. 7 marked with zones indicating apparent brake issues.

The figures are not necessarily to scale and some features may be exaggerated or minimized, such as to show details of particular components.

### DETAILED DESCRIPTION

As required, detailed embodiments of the present disclosure are disclosed herein. The disclosed embodiments are merely examples that may be embodied in various and alternative forms, and combinations thereof. As used herein, for example, “exemplary,” and similar terms, refer expansively to embodiments that serve as an illustration, specimen, model or pattern.

References herein to how a feature is arranged can refer to, but are not limited to, how the feature is positioned with respect to other features. References herein to how a feature is configured can refer to, but are not limited to, how the feature is sized, how the feature is shaped, and/or material of the feature. For simplicity, the term configured can be used to refer to both the configuration and arrangement described above in this paragraph.

In some instances, well-known components, systems, materials or methods have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

While select examples of the present technology describe transportation vehicles or modes of travel, and particularly automobiles, the technology is not limited by the focus. The concepts can be extended to a wide variety of systems and devices, such as other transportation or moving vehicles including aircraft, watercraft, trucks, busses, trolleys, trains, commercial or manufacturing equipment (a forklift, for example), construction machines, agricultural machinery, warehouse equipment, the like, and any other vehicles requiring a form of braking in operation.

While select examples of the present technology describe implementation with user-driven vehicles, the technology may be used with semi- or fully autonomous vehicles.

I. Introduction

In various embodiments, the present disclosure describes an apparatus for automatically diagnosing and prognosing brake system issues at a vehicle. Brake system health issues can include degradation or fault in the brake system, not limited to wear of a brake pad.

Example health issues include but are not limited to brake-line failure, hydraulic-valve failure, air inclusion, water inclusion, brake-fluid boiling, brake-fluid aging, seal and rubber materials fatigue, brake fluid evaporated, vacuum-assist failure, short brake light electrical circuit, high brake temperature, rotor corrosion, uneven wear, brake light switch malfunction, faulty ABS/ESC circuit, brake pedal sticking, and sticky caliper—e.g., piston doesn't retract fully.

While the terms diagnostic and prognostic are used often throughout the present disclosure, the technology is not limited to being configured to perform what may be considered diagnostic and/or prognostic functions. The apparatus is configured to determine, or diagnose, present issues or faults in the break system. The apparatus is in some embodiments configured to identify potential, apparent, or likely issues with the break system—that is, prognose such issues.

The apparatus is in some embodiments configured to report findings of any such determinations to a user, such as the driver, or destination device or personnel, for being acted upon by the user or other interested party, as described more below.

In various embodiments, the apparatus diagnoses and/or prognoses brake system health by actively monitoring brake system parameters, such as by comparing relationships between vehicle deceleration and one or more indicia of braking inputs. Inputs can be initiated by the driver, and/or automated controls, such as an autonomous driving system or automated-braking system (ABS).

Braking input can be indicated in any one or a variety of ways, such as by measured brake-pedal travel, brake-pedal force, and/or brake-line pressure. Other contemplated brake input indicators that can be measured, or calculated, and compared to vehicle deceleration include brake-pedal speed and brake-pedal acceleration.

Autonomous driving or braking systems may or may not include a traditional brake pedal, for pressing by a human driver. The vehicles are considered to include a brake system pedal in whatever structure receives force for initiating or increasing braking. A claim herein referencing a sensor measuring brake pedal force, then, can refer to force applied by a human user to a traditional vehicle brake pedal, to force applied by an autonomous system to the traditional brake pedal, to force applied by an autonomous system to a hardware brake component downstream of the traditional vehicle brake pedal, or to force applied by an autonomous system to a downstream hardware component, such as an autonomous-braking analog or add-on to the traditional brake pedal, for initiating or increasing vehicle braking.

The apparatus are in various embodiments also configured to report results of the diagnosis and/or prognosis to select systems or devices of interested parties. Example recipients include the driver or other vehicle user, a dealership or fleet operator maintaining such vehicles, and a manufacturer, such as an OEM, of the vehicles.

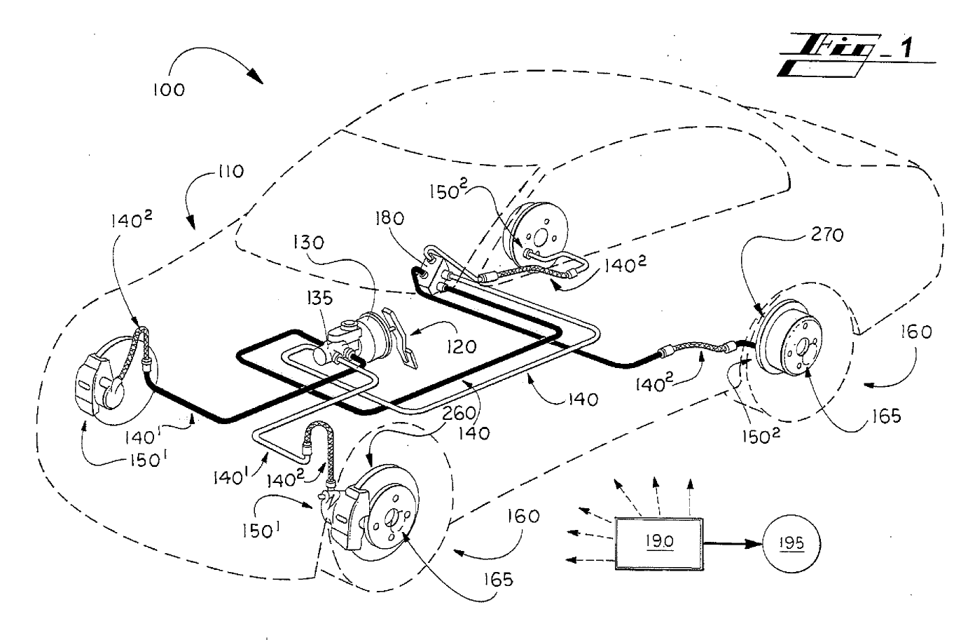

II. FIG. 1—Example Features

Now turning to the figures, and more particularly the first figure, FIG. 1 shows an example vehicle 100, being an automobile. The vehicle 100 includes a brake system 110.

The brake system 110 includes a driver brake pedal, positioned in the area indicated generally by reference numeral 120.

The brake pedal 120 connects to a boost device 130. Typically, the boost device 130 converters force from the brake pedal 120 to hydraulic or pneumatic force to be transferred to brakes arrangements or units 150 via a master cylinder 135.

The brake arrangements 150 are positioned adjacent wheels 160 of the vehicle 100 and include brake pads in various embodiments.

An example boost device 130 is a servo, such as a direct-acting vacuum servo or an indirect-acting vacuum servo.

The boost device 130 and master cylinder 135 are connected by a number of brake lines 140 to the brake arrangements 150. While four brake arrangements 150, and so four primary brake lines 140, are described by way of example here in connection with four vehicle wheels 160, the number of brake arrangements 150 is not limited to four and can include more or less brake arrangements 150. A two-wheeled motorcycle vehicle can include one or two brake arrangements, for instance.

The brake lines 140 can include rigid lines 140¹ and flexible lines 140² leading to the brake arrangements 150.

The brake system 110 can include any type of brake arrangement 150.

By way of example, FIG. 1 shows disc brake arrangements 150¹ at the left and right front wheel positions, and drum brake arrangements 150² at the left and right rear wheel positions.

As mentioned, the brake pedal 120 is shown connected to a boosting device 130. The boosting device 130 is connected to a master cylinder 135, connected in turn to the brake lines 140. An example master cylinder 135 is a tandem master cylinder.

Other braking components can include, for instance, at least one fuse, relay, and/or modulator unit. An example modulator unit is an automatic brake system (ABS) modulator unit. The fuse(s) and relay(s) can be part of an under-hood ABS fuse/relay block, for example.

Another component of most modern brake systems 110 is an ABS control unit 180.

Reference numeral 190 indicates schematically multiple sensors or sensing devices. The sensors 190 are connected to any of multiple brake system 110 components for measuring relevant brake system operations or states.

Example components of the brake system 110 that can be measured by the sensors 190 include the brake pedal 120, the brake lines 140, and the wheels 160. By measuring wheel motion, vehicle speed can be deduced, as can vehicle acceleration/deceleration. Characteristics of the brake pedal 120 that can be measured include pedal travel and pedal force.

Example sensor locations include at or adjacent any brake system component, not limited to those shown and described. Example locations include at a brake pressure control valve, a brake system servo, a brake system master cylinder, or one or more brake-system lines or pipes, being rigid or static and upstream of the brake arrangements 150.

The sensors 190 can also measure vehicle conditions, whether related to or distinct to braking operations, including any sensors available on modern vehicles. From some of the sensors 190, standard onboard vehicle parameters can be determined, estimated or deduced, for instance.

The sensors 190 in various embodiments include at least one accelerometer, measuring vehicle acceleration in any direction. Readouts from the accelerometer can be used in operations of the present technology, instead of or along with acceleration data generated based on other sensors, such as feedback from one or more wheel-speed sensors.

As another example, the sensors 190 can include one or more sensors indicating vehicle pose, such as vehicle pitch, yaw, roll, or change or rate of change of these indicators, over time. The feedback can be used in various operations of the present technology.

The sensors 190 can include those used by modern ABS systems to determine whether some automated braking should be instituted. Feedback from one or more of these sensors can indicate directly or indirectly conditions affecting braking, such as snow, ice, dirt road, or other road or other factor affecting braking. This feedback can also be used in various operations of the present technology, as described more below.

As another example, the sensors 190 can include a vehicle height sensor. Data from the height sensor can indicate a load of the vehicle 100, which can also be considered in operations of the present technology.

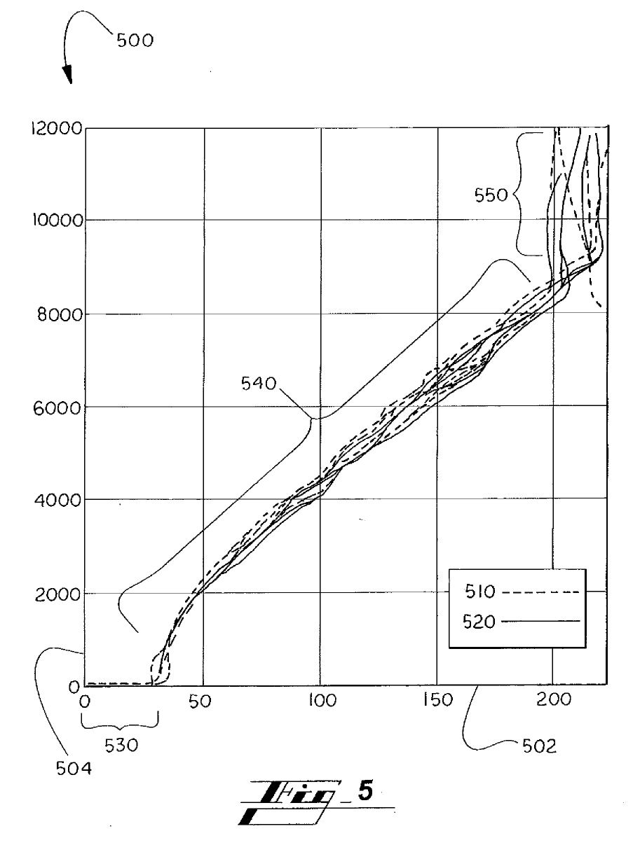

Output of the sensors 190 is indicated collectively by transfer oval 195, which continues to the flow of FIG. 4.

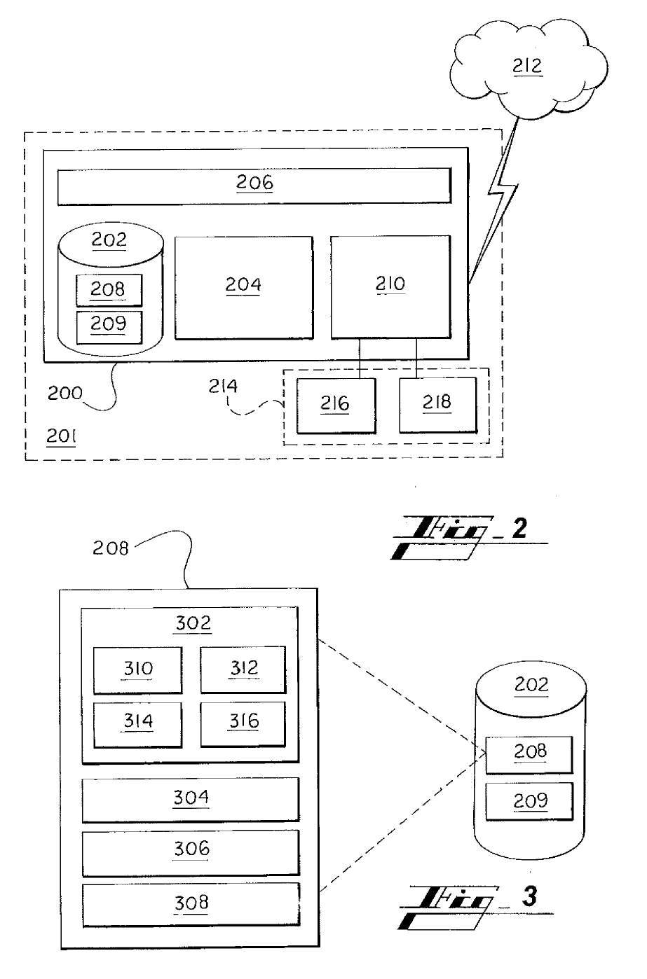

III. FIG. 2—Computing Elements

Output 195 of the sensors 190 in FIG. 1 is processed by specially configured computing hardware and software. FIG. 2 shows an example computer or computing system 200, for use in accordance with embodiments of the present technology.

In various embodiments, the computer system 200 includes an application or program operating on a mobile device, such as a driver or other vehicle-user smart phone, tablet, or wearable.

The computer system 200 is in some embodiments part of a greater system 201. In various embodiments, the greater system 201 includes the vehicle 100 and/or a remote system, remote to the vehicle 100.

In various embodiments, the computer system 200 is part of an established on-board vehicle computer system (OBC) as the greater system 201, such as a vehicle health management (VHM) system.

An example remote greater system 201 is a computer system of a manufacturer of the vehicle 100 or of a service center, such as a dealership or fleet operator, maintaining such vehicles.

In some implementations, the remote system includes a computer system of an owner or user of the vehicle, such as a driver, driver's parents, or employer.

In various embodiments, the computer system 200 is part of a remote-data, customer-service, and/or control center. An example control center is the OnStar® control center, having facilities for interacting with vehicles (e.g., telematics) and users. (ONSTAR is a registered trademark of the OnStar Corporation, which is a subsidiary of the General Motors Company.) The control center can communicate with the user via the vehicle 100 or other device, such as a user phone or other user mobile communication device, via wire or short- or long-range communications, such as satellite or cellular communications.

The computer system 200 can be implemented in any of a variety of ways, such as in the form of a server, within a mobile communications device—e.g., smart phone application, or other.

Although connections are not shown between all of the components illustrated in FIG. 2, the components can interact with each other to carry out apparatus functions.

As shown, the computer system 200 includes a memory, or computer-readable storage device 202, such as volatile medium, non-volatile medium, removable medium, and non-removable medium. The term computer-readable media and variants thereof, as used in the specification and claims, refer to tangible or non-transitory, computer-readable storage devices.

In some embodiments, storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The computer system 200 also includes a processing hardware unit 204 connected or connectable to the computer-readable storage device 202 by way of a communication link 206, such as a computer bus.

The processing hardware unit 204 can include or be multiple processors, which could include distributed processors or parallel processors in a single machine or multiple machines. The processing hardware unit 204 can be used in supporting a virtual processing environment.

The processing hardware unit 204 could include a state machine, application specific integrated circuit (ASIC), programmable gate array (PGA) including a Field PGA, or state machine. References herein to the processing hardware unit executing code or instructions to perform operations, acts, tasks, functions, steps, or the like, could include the processing hardware unit performing the operations directly and/or facilitating, directing, or cooperating with another device or component to perform the operations.

The computer-readable storage device 202 includes computer-executable instructions, or code 208. The code 208 is in various embodiments arranged in storage modules of the storage device 202. The modules store computer-readable instructions executable by the processor 204 to perform the functions or operations of the computer system 200 described herein.

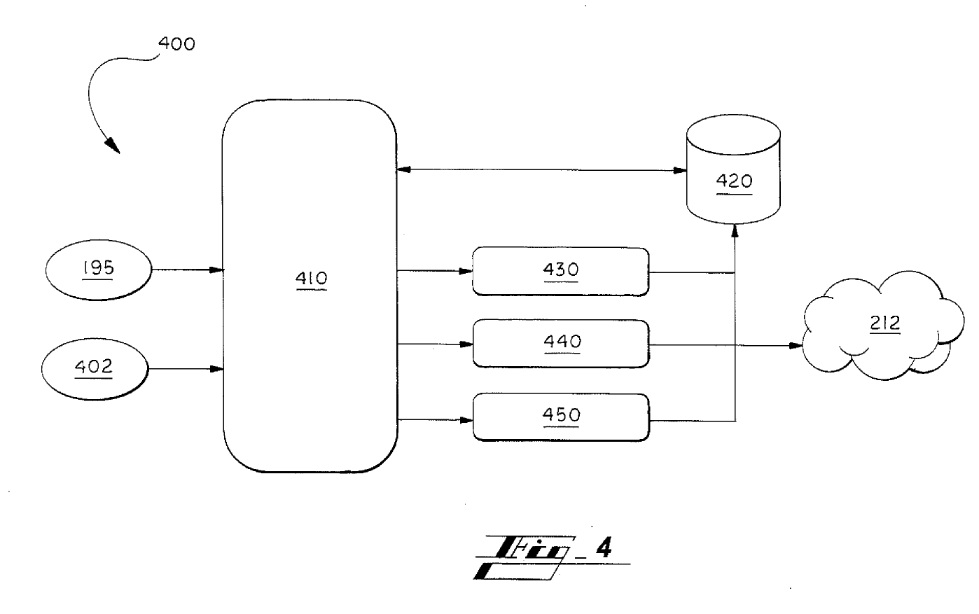

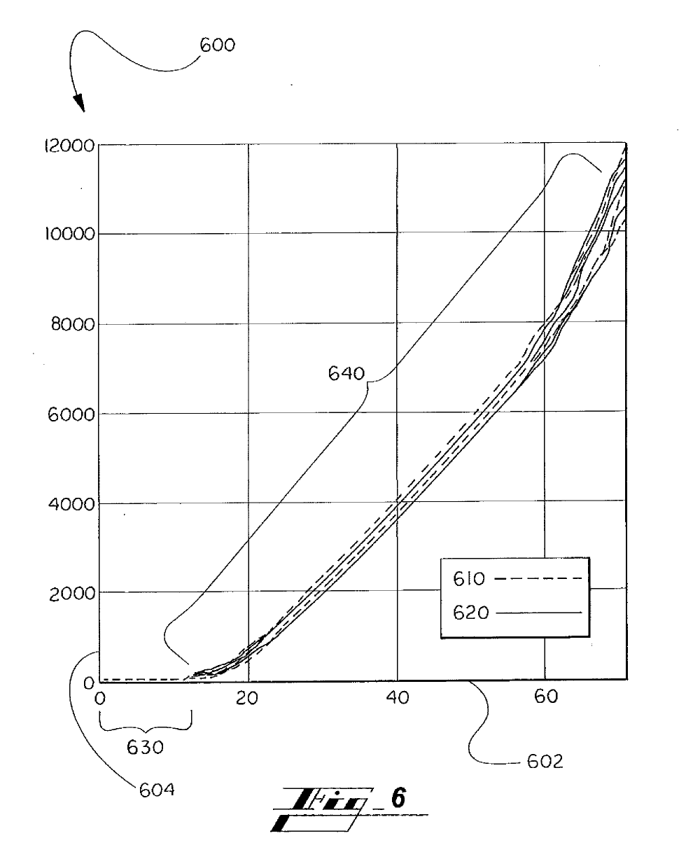

Each of the modules can be referred to in a variety of ways without departing from the scope of the present technology, such as by terminology indicating module function. Examples modules of the code 208 are indicated by reference numerals 302, 304, 306, 308 in FIG. 3, and described more below in connection with FIGS. 3 and 4, and further with respect to FIGS. 5-8.

The computer-executable instructions 208 are executable by the processing hardware unit 204 to cause the processing hardware unit 204, and thus the computer system 200, to perform any combination of the functions described in the present disclosure.

In various embodiments, the storage device 202 also includes ancillary components 209, such as additional software (e.g., modules) and/or data supporting performance of the processes of the present disclosure. In various embodiments, the ancillary components 209 include historic brake system-related data. In some implementations, the ancillary components 209 include calibration data, such as brake system component or brake system sensor calibration data. The ancillary components 209 can include a user profile, which can include default or user-set preferences, such as regarding preferred thresholds triggering alerts, notification timings, means of notifications, the like, or other.

The computer system 200 further comprises an input/output (I/O) device 210, such as a wireless transceiver and/or a wired communication port. The processing hardware unit 204, executing the instructions 208, sends and receives information, such as in the form of messages or packetized data, to and from one or more devices or networks 212. An example network 212 is a communication network, such as the Internet.

Destinations for data in various embodiments include computing devices or systems of vehicle maintenance entities, such as dealerships, vehicle manufactures, drivers, owners (e.g., fleet owners), and customer control centers, such as the OnStar® control center mentioned above.

In some embodiments, such as when the computer system 200 is implemented within a vehicle 100, the computer system 200 includes or is connected to one or more local input/output devices 214.

In various embodiments, local input devices 216 include various vehicle sensors of or associated with the brake system, such as any of the sensors 190 mentioned above in connection with sensing vehicle characteristics including brake system characteristics.

The local input devices 216 can include any standard local inputs of modern vehicles, such as positioning system components (e.g., GPS receiver), radar systems, laser systems, vehicle height sensors, and camera systems.

In various embodiments, local output devices 218 include one or more vehicle-user interfaces (VUI) by which the computer system 200 provides information to the vehicle driver. Example VUls include display screens, speakers, and tactile actuators. Some output devices 218 also serve as input devices 216, such as a touch-sensitive display screen, or a combined microphone/speaker device.

Other example output devices 218 include any automated control system of the vehicle 100, such as a fully autonomous or semi-autonomous driving system, or an automatic-braking system (ABS).

In contemplated embodiments, the inputs and outputs 216, 218 include applications such as social-media, music, traffic, and weather applications installed at the vehicle 100 and/or user mobile device.

Functions of the computer system 200 are referenced above and further below in connection with FIGS. 3-8.

IV. FIG. 3—Specially Configured Algorithms and Data Storage

FIG. 3 shows in more detail the data storage device 202 of FIG. 2.

As mentioned for FIG. 2, the data storage device 202 includes primary code 208 and ancillary code or data 209. In various embodiments, any of the code 208, 209 is arranged in one or more modules.

In FIG. 3, modules are indicated by reference numerals 302, 304, 306, and 308. The modules 302, 304, 306, and 308 are provided by way of example and the code can include other modules for performing any operation described herein, or any function facilitating the operations described.

In contemplated embodiments the modules are arranged in other ways, such as by any or all of the modules being combined, or any single module shown being divided into two or more modules. For instance, the modules can include a prognosis module and a separate diagnostic module, or a combined prognosis and diagnostic module. Recitation, such as in the claims appended hereto to two modules, such as a prognosis and diagnostic module, is equivalent to a single module performing the prognosis and diagnostic functions. And recitation to a single module, such as a prognosis-and-diagnostic module is equivalent to two modules performing the prognosis and diagnostic functions, respectively.

Modules 302, 304, 306, 308 can be referred to in a variety of ways without departing from the scope of the present technology. Each of the modules 302, 304, 306, 308 may be referenced, for instance, by terminology indicating function of the module.

In one embodiment, the modules are arranged as follows: a primary diagnostic-and-prognostic module 302, a data-management module 304, and a reporting module 306. Reference 308 indicates expressly the fact that the system 200 can include other modules.

Other example terms for these modules include, for the primary diagnostic-and-prognostic module 302, D&P module, prognostic module 302, diagnostic module, issue-determination module, fault-determination module, the like or other related to the functions of this module. The module 302 is described more below, including with reference to the flow 400 of FIG. 4 and the graphs of FIGS. 5-8.

Other alternative terms for the modules include, for the data-management module 304, data-handling module, data-procurement-and-storage module, the like or other related to the functions of this module, described further below.

The reporting module 306 may be referred to by other terms, such as alert module, results module, warning module, output module, the like or other related to the functions of this module, described more below.

Any of the functions of the modules 302, 304, 306, 308 can be divided into one or more sub modules. By way of example, the first module 302 is shown having four sub-modules 310, 312, 314, 316.

In various embodiments, the first sub-module 310 relates to receiving input data. Example input data includes sensor data. The input data can also include data indicating, directly or indirectly, contextual information that the system can use in diagnosing an existing or potential brake system fault. Examples of such input data include data indicating road slope (e.g., include, decline, and/or banking), road conditions (e.g., icy, gravel, snow, clear, etc.), vehicle load conditions (via, e.g., vehicle height sensor, seat sensor, truck bed sensor, and/or suspension sensor), the like or other.

In various embodiments, the second sub-module 312 causes the processor to perform functions related to interfacing with data storage. The data storage can be local and/or remote to the computer system 200, such as that indicated schematically in FIG. 4 by reference numeral 420. Data exchanged through the connection can include, data being sent to the data storage 420 and data sensed at the sensors 190. Data exchanged through the connection can also include data created using the sensed data, such as conclusions, determinations, or compilations of the sensed data at a point in time or over time. The data exchange can further include receiving data from the data storage 420, such as historic data regarding brake system performance, such as past sensed data, and data created using the past sensed data.

In various embodiments, the third sub-module 314 causes the processor to perform the primary diagnostic and prognostic functions of the present technology. The functions are described further below, mostly in connection with FIG. 4, including regarding block 410 thereof.

In various embodiments, the fourth sub-module 316 causes the processor to perform reporting or other output functions described further below, mostly in connection with blocks 430, 440, 450 of FIG. 4. The functions in various embodiments include interfacing with the other modules 304, 306, 308. The functions can include, for instance, sending data to the data-management module 304, such as for storage to the database 420, or sending results of brake-system analysis to the reporting module 306.

V. FIGS. 4-8—Example Operation Flow and Algorithm

FIG. 4 shows an example process 400 representing algorithms of the present technology.

It should be understood that the steps, operations, or functions of the processes 400 are not necessarily presented in any particular order and that performance of some or all the steps in an alternative order is possible and is contemplated. The processes can also be combined or overlap, such as one or more steps of one of the processes being performed in the other process.

The steps have been presented in the demonstrated order for ease of description and illustration. Steps can be added, omitted and/or performed simultaneously without departing from the scope of the appended claims. It should also be understood that the illustrated process 400 can be ended at any time.

In certain embodiments, some or all steps of the process 400 and/or substantially equivalent steps are performed by a computer processor, such as the computer processor 204 of FIG. 2, executing computer-executable instructions, such as the primary code 208, of a computer-readable medium, such as the data storage device 202. The process is described more in connection with these hardware-based structures by way of example.

Transition oval 195 in FIG. 4 corresponds to the same oval in FIG. 1, indicating monitored data, including output from the sensors 190. The sensor data includes any of the mentioned data regarding brake system performance, such as brake-line pressure, brake-pedal dynamics, and vehicle deceleration. The sensor data can also indicate contextual data that is related, ancillary, or not typically related to brake-system performance. Such contextual data includes, for instance, vehicle load (or a factor, such as vehicle ride height, indicative of load), road slope, road conditions, effects of braking by the powertrain (e.g., downshifting effects), and weather.

Input oval 402 indicates various other input data considered by the system 200. The other input can include, for instance, contextual data from sources other than vehicle sensors 190, such as data indicating road conditions or wind conditions or other weather-related conditions.

Based on at least the mentioned inputs 195, 402, the system 200 at block 410 determines whether there are any existing, apparent, imminent, or potential brake system issues.

The system 200 in various embodiments performs the operations of block 410 using the mentioned diagnostic-and-prognostic module 302. The operations of block 410 in various implementations includes operation of any of the modules and sub-modules described.

In various embodiments, the system 200 at block 410 determines whether there is a healthy relationship between two or more characteristics of the brake system 110. Characteristics of a healthy relationship are, in various embodiments, pre-determined. The pre-determined relationship can include a pre-set range, for instance, wherein relationships inside or outside of the range are flagged as issues or potential issues. Whether an issue is flagged as an issue or potential issue, in various embodiments, depends on factors such as how far the data is inside or outside of the range and/or how often the data is inside or outside of the range, such as for how many braking episodes.

The system 200 at block 410, in various embodiments, determines whether the vehicle decelerates as it should in response to braking input.

Example brake system characteristics analyzed can include any suitable variable indicating brake system input and vehicle deceleration. Example brake system input variables include brake-pedal dynamics, such as brake-pedal distance force brake-pedal travel, or brake-pedal speed, and brake-line pressure.

In various embodiments, the system 200 determining whether there are any present or potential faults or degradation at block 410 analyzes one or more charts, graphs, tables, or other data structure, or analyzes data that can be used to make such structures, even if the structures are not made or rendered. Example graphs are shown in FIGS. 5-7.

FIG. 5 is a graph 500 showing an example of a healthy relationship between brake-pedal force and brake-line pressure. The x-axis, labeled by numeral 502, indicates brake-pedal force measured in Newtons (N). The force can be applied by a driver and/or by an actuator (now shown in detail) of an automated driving or braking system. The force need not be applied at a pedal, per se—for instance, an autonomous driving system may be configured to apply brake pressure, downstream of a brake pedal if there is one. The y-axis, labeled 504, indicates brake-line pressure in kilo Pascals (kPa).

First data lines 510 in FIG. 5 indicate data regarding a front/left brake and second data lines 520 indicate data regarding a front/right brake. While data associated with the left and right front brakes is shown, other data can be analyzed instead or as well, such as rear brake data. The data analyzed can also include an average, mean, medium, or other function of data from measurements associated with various braking arrangements of the vehicle, such as front/rear.

As mentioned, the relationship shown in FIG. 5 is generally healthy.

There is, for instance, a generally consistent and linear relationship between brake force 502 and brake-line pressure 504 in a primary portion 540 of the graph 500, as the brake force and brake-line pressure increase together.

In an initial section 530 of the graph 500, force on the brake pedal begins to increase, such as in response to a driver touching the brake pedal. The brake-line pressure 504 increases little to nil in the area 530 because the brake system of the example has a buffer built in so that slight touches to the brakes initiate little to no increase in brake-line pressure.

In a trailing section 550, various factors can cause the data lines to stray, or get noisy. Example factors include effects of the automated braking system (ABS). The system 200 is in various embodiments configured—e.g., programmed—to consider (e.g., filter out or otherwise disregard) such effects so that such noise is not flagged as problematic.

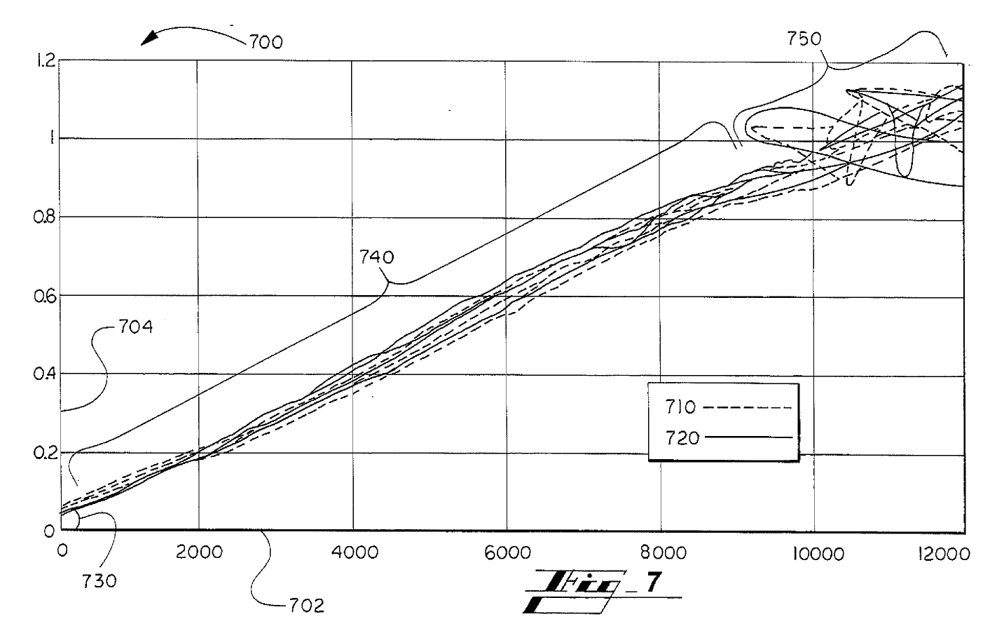

The graph 600 of FIG. 6 shows an example relationship between brake-pedal travel and brake-line pressure. The x-axis 602 indicates brake pedal travel in millimeters (mm). The y-axis 604 again indicates brake-line pressure, again in kilo Pascals (kPa).

The lines 610, 620 indicate data correspond respectively to the left and right brakes.

The relationship shown in FIG. 6 is generally healthy. There is, for instance, a generally consistent and linear relationship between brake travel 602 and brake-line pressure 604 in a primary portion 640 of the graph 600, as the brake travel and brake-line pressure increase together.

The initial section 630 again shows no or negligible brake-line pressure increase, for the reasons provided in connection with the analogous section 530 in FIG. 5.

FIG. 6 is not sized to show a trailing section (e.g., where brake-pedal travel exceeds 80 mm), like the trailing section 550 in FIG. 5, but if a trailing section were shown in FIG. 6, the data lines there would likely be noisy like those in the trailing area 550 of FIG. 5, and could likewise be filtered out or otherwise disregarded in seeking data to flag as problematic.

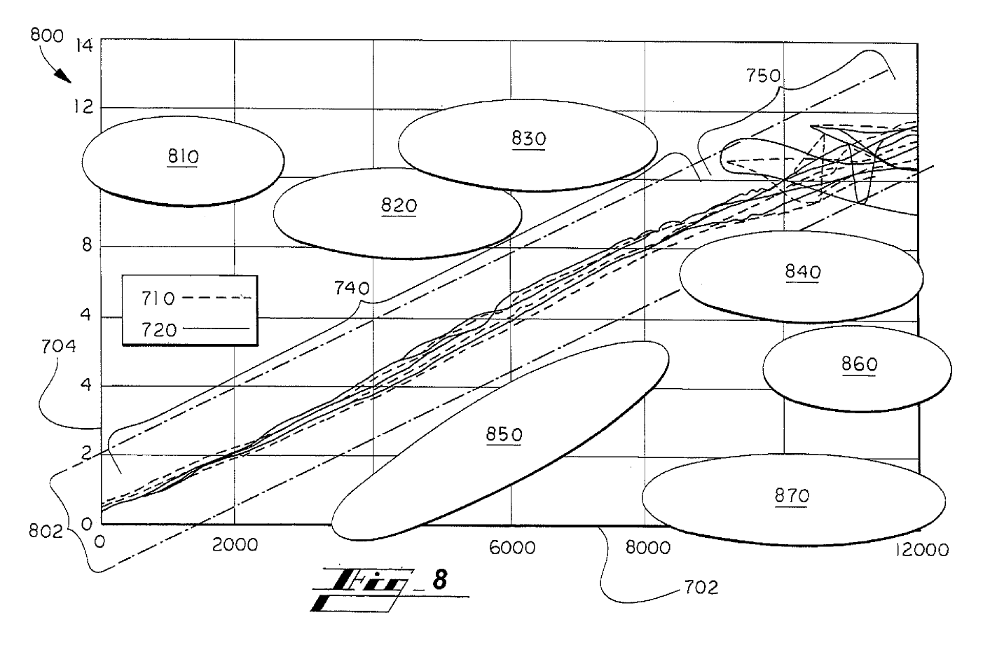

FIG. 7 is a graph 700 showing example relationships between brake-line pressure and vehicle deceleration. The x-axis 702 indicates brake-line pressure, again in kilo Pascals (kPa). The y-axis 704 indicates vehicle deceleration in terms of gravity (g). This deceleration, like all variables described herein, can be represented in other units—here, deceleration can alternatively be represented in terms of m/s², for instance.

The relationship shown in FIG. 7 is also healthy. There is, for instance, a generally consistent and linear relationship between brake-line pressure 702 and vehicle deceleration 704 in a primary portion 740 of the graph 700, as the brake-line pressure and vehicle deceleration increase together.

The graph 700 of FIG. 7 does not include an initial section like the initial sections 530, 630 of FIGS. 5 and 6, wherein increase in the x-axis variable (pedal dynamics—force on pedal or pedal travel) does not increase the y-axis variable (brake-line pressure) for a brief period. In FIG. 7, there is a small initial section 730 wherein the vehicle has begun decelerating before the brake-line pressure starts increasing, or before the brake-line pressures starts increasing notably. The phenomenon can relate to any of a variety of normal conditions, such as to the fact that drivers typically release the accelerator, or gas pedal, prior to pressing the brake pedal. The vehicle will thus be decelerating some prior to brake-line pressure increase.

Like FIG. 5, FIG. 7 is sized to show a trailing section 750 comprising acceptable noise for the data lines 710, 720, corresponding respectively to the left and right brakes.

As mentioned, the system 200 determines whether there are any present or potential (e.g., slight, likely, etc.) faults or degradation by analyzing one or more graphs, charts, or tables, or other data structure, such as the graphs shown in FIGS. 5-7, or analyzes data that can be used to make such data structures.

FIG. 8 shows the graph of FIG. 7 but with the graph 800 marked with example threshold areas and zones indicating existing and potential brake issues. The system 200 analyzes the data to determine whether the data indicates that any of the data lines 710, 720 are disposed in an undesirable manner.

In various embodiments, determining whether the data indicates that any of the data lines 710, 720 are disposed in an undesirable manner includes determining whether any of the lines 710, 720, in connection with at least a primary portion 740 of the data collected, extend beyond a pre-established issue threshold or range 802.

In various embodiments, determining whether the data indicates that any of the data lines 710, 720 are disposed in an undesirable manner includes determining whether any of the lines 710, 720 extend, in at least the primary portion 740, to any of one or more pre-established warning areas or zones 810, 820, 830, 840, 850, 860, 870.

The warning zones 810, 820, 830, 840, 850, 860, 870 shown are only examples, and the zones can have other sizes, shapes, and/or locations, and other zones can be pre-established and considered in the determination, without departing from the scope of the present technology.

Each of the example zones in various embodiments corresponds to one or more pre-determined brake issues. As examples, the zones can relate to the following pre-determined brake issues: brake drag (810), brake pad misalignment (820), incorrect pad installed (830), high brake temperature fade (840), brake fluid aging (850), booster failure 860), and brake line leaks (870).

In some cases, more than one pre-determined brake issue can be associated with a zone, or zones can overlap. As an example of overlapping, the second and third zones 820, 830 are shown overlapping.

As an example of a zone being associated with more than one potential brake issue (e.g., fault or degradation condition), the fifth zone 850 in one implementation is associated with any one or more of brake fluid aging, air inclusion, and water absorption.

As another example of a zone being associated with more than one potential brake issue, the seventh zone 870 in various implementations is associated with either or both of a brake line leak and a condition of the brake-line fluid boiling.

In various embodiments, the system 200 is configured to set or adjust the problem area(s) 802 or zone(s) 810, etc. based on contextual data. The area(s) or zone(s) can be set or adjusted based on road slope, road conditions (e.g., icy, wet, type of road surface, etc.), vehicle load, and/or weather (e.g., temperature) for instance. In this way, the system 200 is configured to expect different deceleration characteristics based on the context in which the braking is occurring. Alternatively, the system 200 can be configured to, after determining an apparent issue, determine that, at least for the time being, the issue will not be flagged based on consideration of context, such as a gravel portion of the road in which the subject braking was performed.

As referenced, in various embodiments, the system 200 is configured so that data-line noise in the trailing portion 750 is not flagged as problematic. With reference to FIG. 8, for instance, though some of the lines 710, 720 extend outside of the pre-set issue threshold area 802, the same are not consider problematic for any of various reasons, such as the reasons provided above in connection with the trailing area 550 of FIG. 5.

In various embodiments, a brake system issue can be determined present, potential, nascent, etc., even though lines 710, 720 stay within one threshold area, if any line extends beyond another area. For instance, note that warning zone 840 is disposed partially within the threshold area 802.

In some embodiments, all warning zones are disposed outside of such a threshold area 802.

In a contemplated embodiment, anywhere outside of the threshold area 802 is considered a warning zone.

The determinations of block 410 are performed over time. The system 200 is in various implementations configured to filter out instances in which associated data might otherwise seem to indicate a brake system issue. If a single operation of the brakes resulted in data defining a line 710 extending outside of the threshold area 802, for instance, the system 200 could be configured to consider the occurrence in connection with other information, such as how the same line (e.g., right/front brake pressure vs. vehicle decal) is disposed in one or more past braking episodes and/or one or more subsequent braking episodes. It may be, for example, that the brake system or a sensor experienced a non-problematic, anomaly performance. Or, it may be that external factors such as a steep road decline, or other condition affected braking, were present temporarily and excuse what the system would otherwise consider problematic.

The system 200 is in some implementations configured to learn from present and/or past braking situations. The system 200 could learn by associating a non-flag condition, or performance anomaly, with braking conditions that occur under particular circumstance or circumstances. An example association is associating a slow deceleration with a certain grade slope, or the road being wet. The learned associations can be represented by data stored at the local storage 202 and/or the remote storage 420, for future use in analyzing brake system performance.

While the example trouble zones 810-870 and threshold area 802 are shown in connection with FIG. 8, the system 200 can instead or also be programed to consider such zones or areas in connection with other braking-system relationships. The system 200 can be programed to consider such zones or areas in connection with the relationship of brake force to brake-line pressure (FIG. 5), or brake travel to brake-line pressure (FIG. 6), for instance.

Or the system 200 can be programed to consider such zones or areas in connection with a relationship between brake force and vehicle deceleration, between brake travel and vehicle deceleration, the like or other (each corresponding graph not shown expressly). In various embodiments, the system 200 simultaneously or otherwise considers more than one such relationship in determining whether a brake-system issue is present or apparently nascent or likely.

In various contemplated embodiments, the system 200 is configured to compare left-side braking with right-side braking. The system 200 could compare left and right brake-line pressures, for instance. Results can include identifying existing or likely vehicle pull from uneven braking.

With continued reference to FIG. 4, the system 200 determines which of multiple subsequent operations should be taken based on the various inputs 195, 402. Example subsequent actions are summarized in connection with FIG. 4.

Example subsequent operations are indicated by reference numerals 430, 440, 450 in FIG. 4. The operations are in various embodiments performed by the processor 204 executing code of any or all of the mentioned modules 302, 304, 306.

Example subsequent actions include storing, to a local and/or remote storage(s) 202, 420, data associated with the inputs 195, 402, or data arranged by processing of the inputs 195, 402.

In various embodiments, the operations can be associated generally with levels of alert, such as from lowest to highest.

With further reference to FIG. 4, for instance, the first group of operations 430 can be associated with no alert, or a healthy brake system, the second operations 440 with a low or medium level of alert and the third with a higher or high level of alert. The system 200 can be configured with more or less subsequent groups, such as the following four instead of three: a healthy group, a low-alert group, a medium-alert group, and a high-alert group.

In various embodiments, the system 200 at block 410, or in the subsequent operations 440, 450, also determines one or more apparent brake-system issues with particularity. The system 200 can in these parts of the algorithm 400 determine for instance that the brake-system issue being reported relates to brake pad alignment and/or brake pad temperature. It may be, for instance, that not only was a non-recommended type of brake pad installed, but it was installed improperly, or became misaligned.

The system 200 can determine the apparent issue with particularity using sensor data 195 and/or other data 402, such as by analyzing relationships between two or more sets of data, as described in connection with the ovals of FIG. 8.

Input data can be received and/or stored by the system 200 using the data-management module 304, for instance. Determining existing or potential issues can be performed by the system 200 using the diagnostic-and-prognostic module 302, for instance.

The system 200 in some circumstances performs one or more pre-determined system diagnostic evaluations in response to the system 200 identifying a particular problem or determining that there may be an issue. The system 200 may be configured to, for instance, in response to determining that a data line 710, 720 falls outside of the range 802, check carefully various brake-system functions. While a brake-line pressure slightly below a normal range may not otherwise appear problematic, the system 200 can determine that an otherwise relatively slight brake-line pressure variance is indeed an actionable fault or issue, requiring maintenance in response to the system 200 determining that the vehicle is not decelerating properly following sufficient brake-pedal force.

With further reference to FIG. 4 and the subsequent operations 430, 440, 450, the first set of subsequent operations 430 in various embodiments includes determining, or follow the computing system 200 determining, that the braking system 110 is operating properly or in normal range. In a contemplated embodiment, data and/or conditions or context associated with the determined normal operation are stored, such as to the local or remote storage 202, 420, for later use in analyzing brake system performance.

The first operations 430 can further include reporting the conclusion(s) reached. The system 200 can be configured to perform the reporting operations using the fourth sub-module 316 and/or the reporting module 306.

The system 200 is in various embodiments programmed to send a report or message indicating good health to a recipient or destination. An example recipient includes the driver or other vehicle user, wo can be notified in any of many ways, such as by a vehicle-driver interface (screen, speaker) or a user computing device—phone, laptop, tablet, etc., by way of email, text, etc.

As another example, the recipient can include a seller and/or servicer of the vehicle (e.g., dealership), or of vehicles of the same type. As another example, the recipient can include a maker of the vehicle. As still another example, the recipient can include a customer-support center, such as the OnStar center mentioned above.

Periodic notifications can be provided to the driver, such as in regular notifications the driver already receives from the customer-support center (email, regular, mail, etc.), or special notifications from the center regarding brake-system health in response to the low- or medium-alert situation.

The healthy brake-system report can indicate, for instance, “Your brake system appears healthy based on recent measurements.”

The second example subsequent operations 440 include determining, or follow the system 200 determining, that the braking system 110 is showing at least one problematic tendency, though not rising to a level high enough to indicate an immediate or emergency situation. Data being at or near a triggering condition, but not fully or consistently so, may qualify for the second operations 440.

For instance, the computer system 200 could determine at block 410 that one or more of the data lines 710, 720 are disposed close to or slightly outside of a boundary of the threshold area 802 of FIG. 8. Or the computer system 200 could determine at block 410, for instance, that one or more of the data lines 710, 720 falls near or slightly within one of the pre-identified warning zones 810-870.

Or if the data lines 710, 720 are only temporarily disposed outside of the threshold area 802, or within a trouble zone 810-870, the situation could be flagged at the low, or medium level of risk of the second operations 440.

Again, the system 200 can be programmed to consider whether an incident is an isolated incident, store operation data, such as to the remote database 420, and later use the stored data. The system 200 can be programmed to determine that possibly isolated events have been logged over time, and flag such situation as possibly problematic in response to the repeated indications, even if each event taken alone is relatively slight and apparently benign.

The second operations 430 can also include reporting the conclusion(s) reached. As provided, the system 200 can be configured to perform reporting operations using the fourth sub-module 316 and/or the reporting module 306.

The system 200 is in various embodiments programmed to send a report or message indicating the possibly or slightly problematic brake-system health to any recipient or destination, such as those described above. Recipients can act on the report in one or more pre-determined manners. The driver may determine to take the vehicle in for service.

A dealership can contact the driver or owner about bringing the vehicle in to be serviced—e.g., repaired or maintained. Or dealership servicing can, for instance, institute some preventative maintenance, targeted at obviating or mitigating an issue indicated by the report, on the subject vehicle and/or on any applicable vehicles it works on. A vehicle maker could similarly create or alter a design (e.g., brake system or brake-system component(s)) targeted at obviating or mitigating an issue indicated by the report, on the subject vehicle and/or on any applicable vehicles.

The customer-support center, such as the OnStar system, can include notification of the low or medium alert in periodic notifications to the driver, such as in regular notifications the driver already receives from the support center, or special notifications regarding brake-system health.

The low or medium report can indicate, for instance, “While the brake system appears healthy overall, recent data indicates the brake pads on the right rear assembly are rising above preferred temperatures occasionally—Please take the vehicle to the dealership for analysis soon [or, “within the next week, etc.].”

Or, “While the brake system appears healthy overall, recent data indicates the brake pads on the right rear assembly are rising above preferred temperatures occasionally—the system will continue to monitor operation and advise if there appears to be a problem.”

Or, “While the brake system appears healthy overall, recent data indicates the brake pads on the right rear assembly are rising above preferred temperatures occasionally—gentle braking and taking the vehicle to the dealership for analysis is recommended.”

The third example subsequent operations 450 include determining, or follow the system 200 determining, that the braking system 110 is exhibiting problematic performance. Data being at or within a triggering condition can qualify for these operations 450

For instance, the computer system 200 could determine at block 410 and/or 450 that one or more of the lines 710, 720 are disposed to a large degree outside of the boundary of the threshold area 802 of FIG. 8. Or the computer system 200 could determine at block 410 and/or 450, for instance, that one or more of the lines 710, 720 within one of the pre-identified trouble zones 810-870.

Or if a data line(s) falls repeatedly or consistently outside of the threshold area 802, or repeatedly or consistently within a trouble zone 810-870, the situation could be flagged at the high level of risk associated with the third operations 450.

The third operations 450 can also further include reporting the conclusion(s) reached. As provided, the system 200 can be configured to perform reporting operations using the fourth sub-module 316 and/or the reporting module 306.

The system 200 is in various embodiments programmed to send a report or message indicating the problematic brake-system health to a destination, such as those described above.

The high-level alert or warning report can indicate, for instance, “A brake system fault has been detected—please have the brake system evaluated before further vehicle operation.” Or, “The front left brake pads are misaligned—please have the pads aligned as soon as possible before further vehicle operation.”

Recipients—e.g., user, personnel, or systems—can act on the report in one or more pre-determined manners. A driver or vehicle user may determine to stop using the car immediately, or not use the vehicle after reaching a present destination, and have the vehicle serviced before further use. A dealership can contact the driver or owner about bringing the vehicle in to be serviced.

The dealership could also institute some preventative maintenance, targeted at obviating or mitigating an issue indicated by the report, on the subject vehicle and/or on any applicable vehicles it works on.

A vehicle maker could similarly create or alter a design (e.g., brake system or brake-system component(s)) targeted at obviating or mitigating an issue indicated by the report, on the subject vehicle and/or on any applicable vehicles.

The customer-support center, such as the OnStar system, can include notification of the high alert or warning in periodic notifications to the driver or vehicle user, such as via the vehicle (e.g., screen, speakers) or user mobile device, in regular notifications (e.g., by mail or email) already sent to the user from the support center, or a special notification regarding brake-system health in response to the high-alert situation.

VI. Select Advantages

Many of the benefits and advantages of the present technology are described above. The present section restates some of those and references some others. The benefits described are not exhaustive of the benefits of the present technology.

The technology in various embodiments actively helps drivers or vehicle users or owners maintain healthy vehicles, and particularly healthy brake systems. The assistance includes detecting, identifying, and predicting potential brake system malfunction or degradation early by real-time brake-system monitoring. In some implementations the monitoring is performed over time and can consider historic performance.

The technology in various embodiments improves vehicle reliability by proactively alerting customers or service centers timely about potential or existing issues, allowing them to take timely corrective or maintenance actions. The technology therein can also allow remote entities, such as vehicle manufactures, dealerships, or other service centers to obtain field performance data regarding vehicle brake systems, and act on the real-time analysis in any of various ways including those described above.

The technology in various embodiments promotes safety by proactively avoiding poor brake performance, and avoiding situations in which a driver is not at a destination and cannot use their vehicle.

In various embodiments the technology facilitates field data analytics and allows entities such as vehicle service centers or manufacturers (e.g., OEMs) to make early remedial, proactive, or preventative enhancements.

The technology in various embodiments promotes vehicle driver or owner satisfaction with the vehicle.

The technology in various embodiments is a cost-effective improvement using mostly hardware already present on some modern vehicles.

VII. Conclusion

Various embodiments of the present disclosure are disclosed herein.

The disclosed embodiments are merely examples that may be embodied in various and alternative forms, and combinations thereof.

The above-described embodiments are merely exemplary illustrations of implementations set forth for a clear understanding of the principles of the disclosure.

Variations, modifications, and combinations may be made to the above-described embodiments without departing from the scope of the claims. All such variations, modifications, and combinations are included herein by the scope of this disclosure and the following claims.

What is claimed:

1. An apparatus, for prognosing a vehicle brake-system health issue, comprising:
a processing hardware unit; and
a non-transitory computer-readable storage device comprising a prognostic module configured to cause the processing hardware unit to determine, based on data received from a first sensor configured to measure a brake system input and from a second sensor configured to produce output indicative of vehicle deceleration, whether there is an existing or potential brake-system health issue.

2. The apparatus of claim 1, further comprising the first sensor and the second sensor.

3. The apparatus of claim 1, wherein the brake system input comprises one or both of an amount of brake-pedal displacement and an amount of force applied to a vehicle brake pedal.

4. The apparatus of claim 1, wherein the second sensor comprises at least one of an accelerometer and a vehicle wheel-speed sensor, output of the wheel-speed sensor over time indicating vehicle deceleration.

5. The apparatus of claim 1, wherein:
the prognostic module is configured to cause the processing hardware unit to receive contextual data; and
the prognostic module bases determination of whether there is the existing or potential brake-system issue on the contextual data in addition to the data received from the first sensor and the second sensor.

6. The apparatus of claim 5, wherein the contextual data indicates at least one of:
a vehicle load;
a road slope;
a road surface condition;
a vehicle height; and
a weather condition.

7. The apparatus of claim 1, wherein:
the prognostic module causing the processing hardware unit to determine whether there is an existing or potential brake-system health issue, yields a brake-system health determination; and
the non-transitory computer-readable storage device comprises a reporting module configured to cause the processing hardware unit to deliver a communication corresponding to the brake-system health determination to a destination.

8. The apparatus of claim 7, wherein the destination comprises at least one of:
a vehicle-user mobile communication device;
a remote computing system of a customer-support center;
a remote computing system of a vehicle manufacturer;
a remote computing system of a service center servicing vehicles like the vehicle;
a remote computing system of a vehicle dealer; and
a remote computing system of a vehicle designer.

9. The apparatus of claim 7, wherein the communication includes a recommended remediation for the brake-health issue.

10. The apparatus of claim 1, wherein the prognostic module bases determination of whether there is an existing or potential brake-system issue on multiple pieces of data received from the first sensor and the second sensor over time and/or on historic information related to vehicle braking performance.

11. The apparatus of claim 1, wherein the prognostic module, in causing the hardware processing hardware unit to determine whether there is the existing or potential brake-system issue, determines whether the sensor data falls within or outside of a pre-set threshold.

12. The apparatus of claim 1, wherein:
the non-transitory computer-readable storage device comprises a diagnostic module that, when executed by the hardware processing hardware unit, determines a reason for the existing or potential brake-system issue; and
the diagnostic module, when executed by the non-transitory computer-readable to determine the reason for the existing or potential brake-system issue, determines the reason based on the sensor data being within or outside of a pre-set data threshold or pre-established data zone.

13. An apparatus, for prognosing a vehicle brake-system health issue, comprising:
a processing hardware unit; and
a non-transitory computer-readable storage device comprising a prognostic module configured to cause the processing hardware unit to determine, based on data received from a first sensor configured to measure vehicle brake-line pressure and from a second sensor configured to produce output indicative of vehicle deceleration, whether there is an existing or potential brake-system health issue.

14. The apparatus of claim 13, further comprising the first sensor and the second sensor.

15. The apparatus of claim 13, wherein:
the prognostic module is configured to cause the processing hardware unit to receive contextual data; and
the prognostic module bases determination of whether there is the existing or potential brake-system issue on the contextual data in addition to the data received from the first sensor and the second sensor.

16. The apparatus of claim 15, wherein the contextual data indicates at least one of:
a vehicle load;
a road slope;
a road surface condition;
a vehicle height; and
a weather condition.

17. The apparatus of claim 13, wherein:
the prognostic module causing the processing hardware unit to determine whether there is an existing or potential brake-system health issue, yields a brake-system health determination;
the non-transitory computer-readable storage device comprises a reporting module configured to cause the processing hardware unit to deliver a communication corresponding to the brake-system health determination to a destination; and
the communication includes a recommended remediation for the brake-health issue.

18. The apparatus of claim 13, wherein:
the non-transitory computer-readable storage device comprises a diagnostic module that, when executed by the hardware processing hardware unit, determines a reason for the existing or potential brake-system issue; and
the diagnostic module, when executed by the non-transitory computer-readable to determine the reason for the existing or potential brake-system issue, determines the reason based on the sensor data being within or outside of a pre-set data threshold or pre-established data zone.

19. An apparatus, for prognosing a vehicle brake-system health issue, comprising:
a processing hardware unit; and
a non-transitory computer-readable storage device comprising a prognostic module configured to cause the processing hardware unit to determine, based on data received from a first sensor configured to measure a brake system input and from a second sensor configured to measure vehicle brake-line pressure, whether there is an existing or potential brake-system health issue.

20. The apparatus of claim 19, further comprising the first sensor and the second sensor.
